(19) United States
(12) Patent Application Publication
(10) Pub. No.: US 2020/0162597 A1
(43) Pub. Date: May 21, 2020

(54) SYSTEMS AND METHODS FOR CLEANING AND PROTECTING DISPLAYS OF ELECTRONIC DEVICES

(71) Applicant: ZAGG Intellectual Property Law Group, Midvale, UT (US)

(72) Inventor: Dermot Keogh, Sandy, UT (US)

(21) Appl. No.: 16/690,016

(22) Filed: Nov. 20, 2019

Related U.S. Application Data
(63) Continuation-in-part of application No. 29/675,581, filed on Jan. 3, 2019.
(60) Provisional application No. 62/770,090, filed on Nov. 20, 2018.

(51) Int. Cl. H04M 1/02; B08B 7/00; C09J 7/38; C09J 7/20; C09J 7/40

(52) U.S. Cl. CPC H04M 1/0266; B08B 7/0028; C09J 2203/326; C09J 7/203; C09J 7/405; C09J 7/38

(57) ABSTRACT

A system for applying a protective layer to a substrate, such as an electronic device, includes the protective layer, a dust removal layer on a contact surface of the protective layer, and a release film, or release liner, on a dust removal surface of the dust removal layer. The system may also include an application liner on an outer surface of the protective layer, opposite from the dust removal layer. A dust removal adhesive on the dust removal surface may clean a surface of the substrate to which the protective layer is to be secured. The dust removal layer may include two or more separate or separable sections, as well as pair of adjacent tabs on opposite sides of a boundary between adjacent sections of the dust removal layer. The adjacent tabs may facilitate removal of the adjacent sections of the dust removal layer from the contact surface of the protective layer to facilitate adhesion of the protective layer to the surface of the substrate. Methods for cleaning the surface of an electronic device in connection with securing a protective layer to the surface are also disclosed.

### CROSS-REFERENCE TO RELATED APPLICATIONS

A claim for priority to the Nov. 20, 2019 filing date of U.S. Provisional Patent Application No. 62/770,090, titled SYSTEMS AND METHODS FOR CLEANING AND PROTECTING DISPLAYS OF ELECTRONIC DEVICES (“the '090 Provisional Application”) is hereby made pursuant to 35 U.S.C. 119(e). This application is also a continuation-in-part of U.S. Design patent application Ser. No. 29/675,581, filed on Jan. 3, 2019 and titled PROTECTIVE COVER (“the '581 Design Application”). The entire disclosures of the '090 Provisional Application and the '581 Design Application are hereby incorporated herein.

### TECHNICAL FIELD

This disclosure relates to protective layers for the displays of electronic devices and, more specifically, to systems that enable the application of protective layers to the displays of electronic devices, such as smart phones, tablet computers, and the like. This disclosure also relates to methods for applying protective layers to displays for electronic devices.

### SUMMARY

In one aspect, this disclosure includes embodiments of systems for applying protective layers (e.g., sheets, films, etc.) to surfaces of electronic devices. In various embodiments, a system according to this disclosure may facilitate the application of an optically clear protective layer to a display of an electronic device. In other embodiments, a system according to this disclosure may facilitate the application of a decorative protective layer to a surface of an electronic device. Such a system may be referred to as “a system for protecting a display of an electronic device,” as a “protective layer application system,” and, more simply, as a “system.”

In various embodiments, a system according to this disclosure includes, in series, a protective layer, a dust removal layer, and a release film, which may also be referred to as a release liner, in superimposed relation with one another. Such a system may also include (although non-essentially) an application layer over the protective layer; i.e., adjacent to, or over, an outer surface of the protective layer, or on an opposite side, or surface, of the protective layer from the dust removal layer.

The protective layer may be securable in place over a surface of an electronic device. Without limitation, the protective layer may be securable over a display of the electronic device. Alternatively, the protective layer may be securable over another, non-display surface of an electronic device.

The protective layer may include a body with an outer periphery, a contact surface, and an outer surface. An adhesive on the contact surface may secure the protective layer to the display of the electronic device. The adhesive on the contact surface of the protective layer may also be transparent—even optically clear. The contact surface may be positioned against the surface of the electronic device, with adhesive on the contact surface securing the protective layer to the electronic device. The outer surface, which may be located on an opposite side, or surface, of the body from the contact surface, may face away from the surface to which the contact surface is secured and, thus, away from an electronic device when the protective layer is secured to the surface of the electronic device.

The dust removal layer of a system according to this disclosure may include a body with an outer periphery, a contact surface, and a dust removal surface. The dust removal layer may be superimposed with the protective layer. The outer periphery of the body of the dust removal layer may be aligned with the outer periphery of the body of the protective layer. The contact surface of the dust removal layer may be positioned adjacent to or against the contact surface of the protective layer. In embodiments where the contact surface of the protective layer carries an adhesive, the adhesive may secure the contact surface of the dust removal layer to the contact surface of the protective layer. The removal surface of the dust removal layer, which may be located on an opposite of the body from the contact surface of the dust removal layer, may face away from the contact surface of the protective layer and, thus, away from the protective layer. By covering the adhesive on the contact surface of the protective layer (e.g., entirely, etc.), the dust removal layer may prevent contact with the adhesive, as well as contamination of the adhesive.

The dust removal layer may include a single element, or it may include two or more sections. In embodiments where the dust removal layer includes two or more sections, a boundary may be defined between adjacent sections. The boundary extends from one location on the outer periphery of the body of the dust removal layer to another position on the outer periphery of the body of the dust removal layer. The boundary may extend from one edge of the outer periphery of the body of the dust removal layer to another edge of the outer periphery of the body of the dust removal layer. Some embodiments of dust removal layers may include boundaries that extend from one edge of the outer periphery of the body of the dust removal layer to an opposite edge of the outer periphery of the body of the dust removal layer.

The boundary between the adjacent sections of the dust removal layer may enable or facilitate separation the adjacent sections from one another. The boundary may be linear, it may be curvilinear, or it may have any other suitable configuration. The boundary may extend partially through the dust removal layer, it may comprise a sequence of sections that extend completely through the dust removal layer (e.g., perforations, slits, etc.), or it may extend substantially across and completely through the dust removal layer. Alternatively, the boundary may physically separate the adjacent sections from each other (e.g., it may comprise an elongated cut between the adjacent sections, it may comprise a location where one section overlaps an edge of an adjacent section, etc.). In embodiments where the boundary or features thereof extend completely though the thickness of the dust removal layer, they may extend into the adhesive on the contact surface of the protective layer. The boundary may extend only partially into the adhesive between the contact surface of the dust removal layer and the contact surface of the protective layer; thus, the boundary may not extend into the contact surface of the protective layer.

A dust removal layer may include one or more tabs. The tabs may protrude laterally from, or beyond, the outer periphery of the body of the dust removal layer and beyond an outer periphery of a body of the protective layer when the dust removal layer and the protective layer are assembled in a system according to this disclosure. In embodiments where the dust removal layer includes two or more sections, a tab may protrude from the outer periphery of each section of the dust removal layer. In some embodiments, the tabs may be located along a single edge of the outer periphery of the body of the dust removal layer. The tabs of adjacent sections of the dust removal layer may be located adjacent to one another. Adjacent edges of the adjacent tabs may be continuous with the boundary between the adjacent sections of the dust removal layer.

The dust removal surface of the dust removal layer may carry a dust removal adhesive. The dust removal adhesive may adhere to or otherwise removing contaminants (e.g., dust, oils, etc.) from a surface of an electronic device (e.g., a surface to which the protective layer of the system is to be secured, etc.). The dust removal adhesive may comprise a material that can contact the surface of the electronic device and remove contaminants from the surface without leaving a residue (e.g., a residue of the adhesive material, etc.) on the surface.

The release film of a system according to this disclosure may cover the dust removal adhesive. The release film may include a body with an outer periphery, a contact surface, and an outer surface. The release film may be superimposed with one or both of the dust removal layer and the protective layer. The outer periphery of the body of the release film may be aligned with the outer periphery of one or both of the dust removal layer and the protective layer. The contact surface of the release film layer may be positioned against the dust removal adhesive on the dust removal surface of the dust removal layer. The dust removal adhesive may secure the contact surface of the release film in position adjacent to the dust removal surface of the dust removal layer. The outer surface of the release film, which may be located on an opposite of the body from the contact surface of the release film, may face away from the contact surface of the release film and, thus, away from the dust removal layer. By covering the dust removal adhesive on the dust removal surface of the protective layer (e.g., entirely, etc.), the release film may prevent contact with the dust removal adhesive, as well as contamination of the adhesive, until the dust removal adhesive is used to remove contaminants from a surface (e.g., a surface to which the protective layer is to be secured, etc.).

The release film may include one or more tabs that protrude laterally from, or beyond, the outer periphery of its body. When the release film is assembled with the dust removal layer and the protective layer, each tab of the release film may also protrude laterally beyond the outer periphery of the body of the dust removal layer and laterally beyond the outer periphery of the body of the protective layer. In embodiments where the release film includes a plurality of tabs, the tabs may be positioned adjacent to one another, along single edge of the outer periphery of the body of the release film. In some embodiments, each tab of the release film may be superimposed with a tab of the dust removal layer. In other embodiments, including, but not limited to those embodiments where tabs of the dust removal layer protrude from the outer periphery of the body of the dust removal layer, the tab(s) of the dust removal layer may protrude from one edge of the outer periphery of the system while the tab(s) of the release film may protrude from another edge of the outer periphery of the system.

In embodiments where the system includes an application layer, the application layer may be positioned over and secured to the outer surface of the protective layer. More specifically, the application layer may include a body with an outer periphery, a contact surface, and an outer surface. The contact surface of the application layer may face and be secured to the outer surface of the protective layer. The contact surface of the application layer may carry an application layer adhesive, which can removably secure the application layer to the outer surface of the protective layer. A configuration of the contact surface of the application layer, a manner in which the application layer adhesive is applied to the contact surface of the application layer, and/or a formulation the application layer adhesive may enable the application layer adhesive to removably secure the application layer to the outer surface of the protective layer. In some embodiments, the application layer adhesive may enable the application layer to be removed from the outer surface of the protective layer without leaving a residue (e.g., of the application layer adhesive) on the outer surface of the protective layer.

The shapes and lateral dimensions of the protective layer, the dust removal layer, the release film, and the optional application layer may be the substantially the same or, in embodiments where the dust removal layer and/or the release film include one or more tabs, substantially the same.

In another aspect, embodiments of cleaning and protecting a surface of an electronic device, such as a display of the electronic device, edges of the electronic device, a back side of the electronic device, etc., are disclosed. Such a method may include providing a system with a protective layer, a dust removal layer, and a release film. In a specific, but non-limiting embodiment, the system may include a dust removal layer with two sections.

An entirety of the release film may be removed from the dust removal layer of to expose a dust removal adhesive on a dust removal surface of the dust removal layer. With the dust removal adhesive exposed, the dust removal layer may be aligned with the surface of the electronic device and the dust removal adhesive may be placed into contact with a surface of the electronic device. The assembly may be pressed against the surface of the electronic device to ensure that the dust removal adhesive contacts and adheres to contaminants on the surface. In some embodiments, the process may be repeated at least once by pulling the assembly away from (e.g., lifting the assembly off of, etc.) the surface of the electronic device, bringing the dust removal adhesive back into contact with the surface of the electronic device, and optionally pressing (or re-pressing) the assembly against the surface of the electronic device.

With the dust removal layer and, thus, the protective layer aligned with the surface of the electronic device and secured to the surface of the electronic device by way of the dust removal adhesive, a first section of the dust removal layer may be pulled away from the surface of the electronic device. The first section of the dust removal layer may be pulled away from the surface of the electronic device while a second section of the dust removal layer remains on (e.g., adhered to, etc.) another portion of the surface of the electronic device. As the first section of the dust removal layer is pulled away from the surface of the electronic device, contaminants (e.g., contaminants from the surface of the electronic device, etc.) that have adhered to the dust removal adhesive on the first section may also be pulled away from the surface of the electronic device.

While the first section of the dust removal layer is spaced apart from the surface of the electronic device, the first section of the dust removal layer may be removed from a corresponding first portion of the contact surface of the protective layer. Removal of the first section of the dust removal layer from the protective layer may be initiated from a somewhat intermediate location across an edge of an outer periphery of the protective layer. Without limitation, removal of the first section of the dust removal layer may be initiated by pulling a tab of the first section of the dust removal layer (e.g., protruding from a side edge of the assembly, etc.) away from the protective layer. As the first section of the dust removal layer is removed from the first portion of the protective layer, adhesive on a first portion of the contact surface of the protective layer may be exposed and the first portion of the contact surface may be pulled toward the surface of the electronic device, which may enable the adhesive to secure the first portion of the contact surface to the surface of the electronic device.

An elongated pressure front may be applied to the first portion of the protective layer as it is secured to the surface of the electronic device. An elongated pressure front may be generated simply by pulling the first section of the dust removal layer from the intermediate location of the protective layer toward an edge of the protective layer and a corresponding location of the electronic device. An elongated pressure front may also be applied by positioning an application element (e.g., a squeegee, a somewhat flexible card, etc.) over an outer surface of the protective layer (e.g., to an application layer on the outer surface of the protective layer, directly to the outer surface of the protective layer, etc.) and across a portion (e.g., an intermediate portion, etc.) of the protective layer, and moving the application element over the first portion of the protective layer, to an edge of the protective layer.

With the first portion of the protective layer secured to a corresponding portion of the surface of the electronic device, the second section of the dust removal layer may be pulled away from, or lifted off, the surface of the electronic device, carrying contaminants with it. Pulling away the second section of the dust removal layer from the protective layer may occur in a manner that allows the first portion of the protective layer to remain secured to the surface of the electronic device. With the second section of the dust removal layer pulled away from the surface of the electronic device, the second portion of the protective layer may be secured to a corresponding portion of the surface of the electronic device. The second portion of the protective layer may be secured to the surface of the electronic device in substantially the same way the first portion of the protective layer was secured to the surface of the electronic device or in any other suitable manner.

Once the protective layer has been secured to the surface of the electronic device, any bubbles between the protective layer and the surface of the electronic device may be removed (e.g., by application and movement of elongated pressure fronts, etc.). In embodiments where an application layer is positioned on the outer surface of the protective layer, the application layer may be removed from the outer surface of the protective layer (e.g., by pulling, or peeling, the application layer away from the outer surface of the protective layer, etc.).

Other aspects of the disclosed subject matter, as well as features and advantages of various aspects of the disclosure, should become apparent to those of ordinary skill in the art through consideration of this disclosure and the appended claims.

### BRIEF DESCRIPTION OF THE DRAWINGS

In the drawings:

FIG. 1 is a perspective view of a front surface of an embodiment of a system for applying a protective layer to an electronic device;

FIG. 2 shows a top edge view of the embodiment of system shown in FIG. 1;

FIG. 3 shows the front surface of the embodiment of system shown in FIG. 1;

FIG. 4 shows a right edge of the embodiment of system shown in FIG. 1;

FIG. 5 shows a rear surface of the embodiment of system shown in FIG. 1;

FIG. 6 shows a left edge of the embodiment of system shown in FIG. 1;

FIG. 7 shows a bottom edge of the embodiment of system shown in FIG. 1;

FIG. 8 is a diagram providing a cross-sectional representation of an embodiment of a system for applying a protective layer to an electronic device;

FIG. 9 shows a front of an embodiment of a system for applying a protective layer to an electronic device, with a release film of the system pulled partially away from the dust removal adhesive on the dust removal surface of the system;

FIG. 10 provides a rear view of the embodiment of system shown in FIG. 9, with a first portion of a dust removal layer of the system pulled partially away from a contact surface of a protective layer of the system;

FIG. 11 provides a rear view of the embodiment of system shown in FIG. 9, with a release film of the system pulled partially away from the dust removal adhesive on the dust removal surface of the system; and

FIGS. 12-19 illustrate an embodiment of a method for protective a surface of an electronic device.

### DETAILED DESCRIPTION

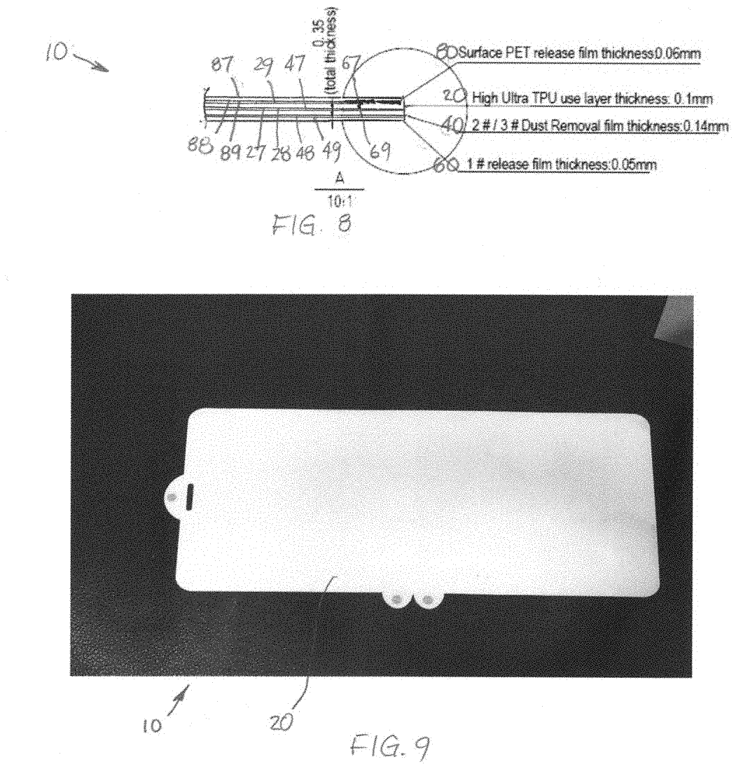

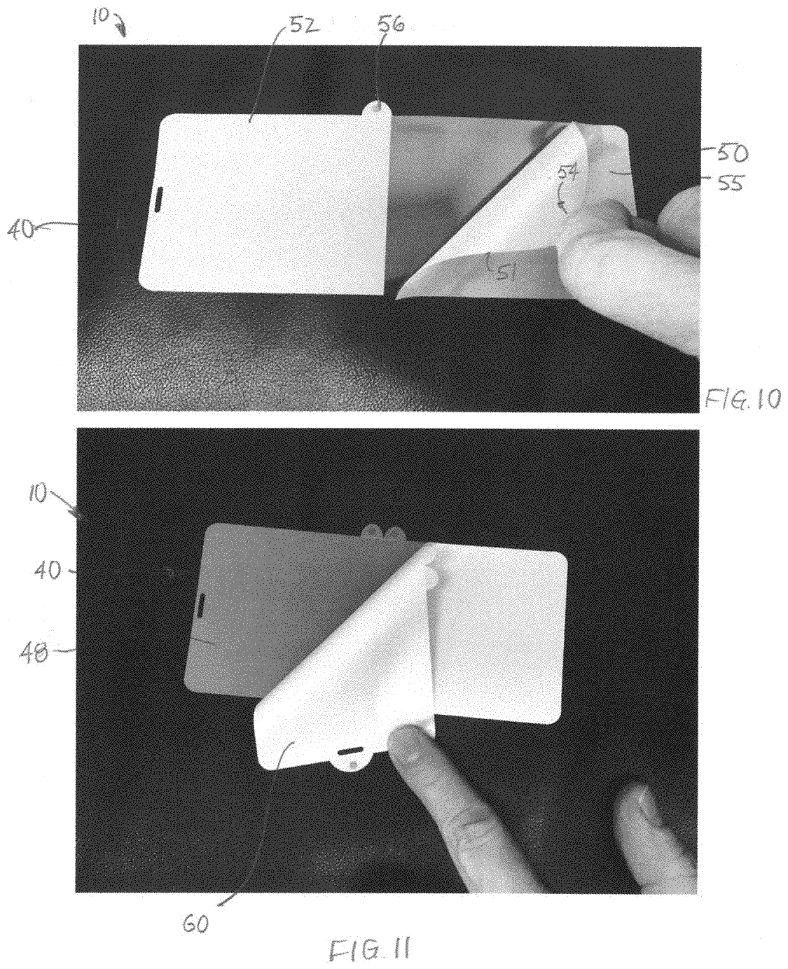

With reference to FIGS. 1-11, an embodiment of a system 10 for applying a protective layer to a surface of a substrate is shown. In various embodiments, the system 10 may have a shape and dimensions that enable it to facilitate the application of a protective layer 20 to a surface of an electronic device, such as a smart phone, a tablet computer, a laptop computer, or the like. The embodiment of system 10 depicted by FIGS. 1-8 facilitates the application of a protective layer 20 over or to a display of a smart phone.

The system 10 may include the protective layer 20, a dust removal layer 40, and a release film 60, which may also be referred to as a release liner. In some embodiments, the, system 10 may also include an application layer 80. The various layers of the system 10 may be superimposed relative to one another and removably secured to each other. More specifically, as best illustrated by FIG. 8, the protective layer 20 of the system 10 may be located atop the dust removal layer 40, which may, in turn, be located on top of the release film 60. The optional application layer 80 may be located on top of the protective layer 20. In the specific, but non-limiting embodiment depicted by FIG. 8, the system 10 may have an overall thickness of about 0.35 mm.

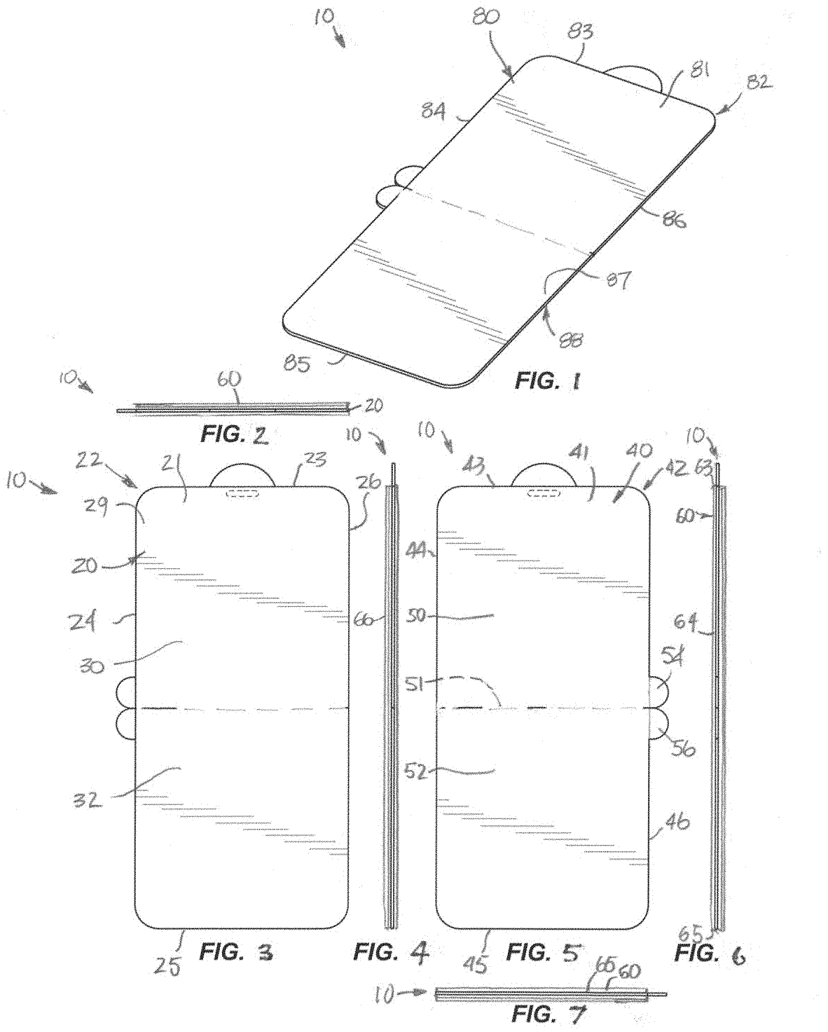

As shown in FIGS. 2-4 and 6-9, the protective layer 20 may include a body 21 with an outer periphery 22. The outer periphery 22 may include a number of (e.g., four, etc.) different edges 23, 24, 25, 26. In some embodiments, the outer periphery 22 may impart the body 21 with a shape that corresponds substantially to a shape of a surface the protective layer 20 is intended to protect (e.g., a shape of a surface of a particular electronic device, etc.). A body 21 with an outer periphery 22 that corresponds substantially to the shape of the surface it is intended to protect may be slightly smaller than the surface it is intended to protect and include one or more cutouts to accommodate features (e.g., a speaker, one or more camera lenses, a proximity sensor, a button, etc.) at the surface.

The body 21 of the protective layer 20 and, thus, the protective layer 20 itself may also include a contact surface 27 and an outer surface 29. The contact surface 27 may be configured for placement adjacent to a surface it is intended to protect. The contact surface 27 may carry an adhesive 28 (e.g., a pressure sensitive adhesive, etc.) that can secure the protective layer 20 to the surface it is intended to protect. The outer surface 29 of the protective layer 20 may be located opposite from, or on an opposite side, or surface, of the body 21 from, the contact surface 27.

In some embodiments, the body 21 of the protective layer 20 may be flexible. Such a protective layer 20 may be defined from a polymer (e.g., a thermoplastic polyurethane (TPU), etc.), such as an optically clear polymer (e.g., an optically clear TPU, etc.). In other embodiments, the body 21 of the protective layer 20 may be rigid. Such a protective layer 20 may be formed from a glass, such as a tempered glass, a sapphire-infused glass, or sapphire. In some embodiments, the glass of a rigid protective layer 20 may be laminated over a polymer (e.g., optically clear TPU, etc.) base. In the specific embodiment depicted by FIG. 8, the protective layer 20 comprises an optically clear TPU film with a thickness of about 0.1 mm.

The adhesive 28 on the contact surface 27 of the protective layer 20 may secure the protective layer 20 to a surface the protective layer 20 is intended to protect. The adhesive 28 may secure the protective layer 20 to a surface for a prolonged period of time (e.g., a month or more, several months, a year or more, etc.). In some embodiments, the adhesive 28 may comprise a pressure sensitive adhesive material. In embodiments where the protective layer 20 is formed from an optically clear material, including embodiments where the protective layer 20 is intended to be placed over a display surface of an electronic device, the adhesive 28 may comprise an optically clear pressure sensitive adhesive material.

With reference to FIGS. 3, 8, and 10, the dust removal layer 40 of the system 10 may include a body 41 with an outer periphery 42. The outer periphery 42 may include a number of (e.g., four, etc.) different edges 43, 44, 45, 46. In some embodiments, the outer periphery 42 may impart the body 41 with a shape that corresponds to or corresponds substantially to a shape of the protective layer 20 (FIG. 1). A body 41 with an outer periphery 42 that corresponds substantially to the shape of the protective layer 20 may lack one or more features of the protective layer 20, such as one or more cutouts of the protective layer 20. A body 41 with an outer periphery 42 that corresponds substantially to the shape of the protective layer 20 may include one or more features in addition to those of the protective layer 20, such as tabs 54, 56.

The body 41 of the dust removal layer 40 may include a single element. Alternatively, as depicted by FIGS. 1, 3, and 5, the dust removal layer may include two or more sections 50, 52, etc. A boundary 51 may be located between adjacent sections 50 and 52 of the dust removal layer 40. The boundary 51 may extend across a width of the dust removal layer 40, for example, from one edge 44 of an outer periphery 42 of the body 41 of the dust removal layer 40 to an opposite edge 46 of the outer periphery 42 (e.g., from one side edge to another side edge, etc.). The boundary 51 may be positioned at an intermediate location between the other pair of opposite edges 43 and 45 of the outer periphery 42 (e.g., between opposite end edges, etc.).

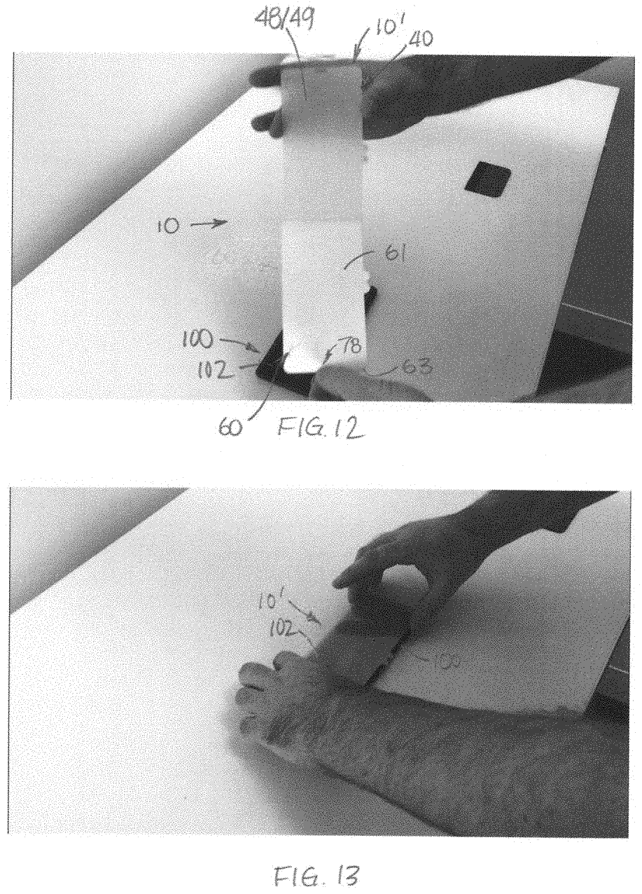

The boundary 51 may be linear, as depicted by FIGS. 3 and 9 or have any other suitable configuration; for example, it may be curvilinear. The boundary 51 may extend completely through a thickness of the body 41 of the dust removal layer 40 (e.g., it may comprise a cut line, etc.) along substantially an entirety (e.g., all but its ends, etc.) or an entirety of a length of the boundary 51. Alternatively, the boundary may comprise a sequence of sections that extend completely through the body 41 (e.g., perforations, slits, etc.). As another alternative, a configuration of the boundary 51 may enable adjacent sections 50 and 52 of the dust removal layer 40 to be physically separated (e.g., torn, broken, etc.) along its length (e.g., it may comprise a score line, an elongated weakened line, etc.).

The dust removal layer 40 may include one or more tabs 54, 56. The tabs 54, 56 may protrude laterally from, or beyond, the outer periphery 42 of the body 41 of the dust removal layer 40. In embodiments where the dust removal layer 40 includes two or more sections 50, 52, a tab 54, 56 may protrude from the outer periphery 42 of each section 50, 52. In the embodiment depicted by FIGS. 1, 3, and 5, the tabs 54, 56 protrude from edge 44 of the outer periphery 42 and are positioned adjacent to one another, on opposite sides of the boundary 51 between the sections 50 and 52 of the dust removal layer 40.

The body 41 of the dust removal layer 40 and, thus, the dust removal layer 40 itself may also include a contact surface 47 and a dust removal surface 48. The contact surface 47 may be positioned adjacent to or against the contact surface 27 of the protective layer 20, as shown in FIG. 8. The adhesive 28 on the contact surface 27 of the protective layer 20 may hold the dust removal layer 40 in place adjacent to the contact surface 27. The dust removal surface 48 may be located opposite from, or on an opposite side, or surface, of the body 41 from, the contact surface 47. The dust removal surface 48 may carry a dust removal adhesive 49.

The body 41 and any tab(s) 52, 54 of the dust removal layer 40 may be flexible. Such a dust removal layer 40 may be defined from a paper product or a polymer film (e.g., polyester (PET), polypropylene (PP), polyethylene (PE), etc.). The contact surface 47 of the dust removal layer 40 may have a configuration that enables it to be readily released the adhesive 28 on the contact surface 27 of the protective layer 20. In some embodiments, the contact surface 47 may comprise a silicone coating, which may or may not include a controlled release additive, as known in the art. In the specific embodiment depicted by FIG. 8, the dust removal layer 40 may comprise a film with a weight of about 2 pounds or about 3 pounds and a thickness of about 0.14 mm.

The dust removal adhesive 49 on the dust removal surface 48 of the dust removal layer 40 may adhere to contaminants (e.g., dust, oils, etc.) upon contacting the contaminants, and may remove the contaminants from a surface to which the protective layer 20 is to be secured. The dust removal adhesive 49 may also hold the release film 60 in place adjacent to the dust removal surface 48 of the dust removal layer 40. In addition, the dust removal adhesive 49 may contact a surface to which the protective layer 20 is to be secured while leaving substantially no residue or no residue on the surface. The dust removal adhesive 40 may comprise a suitable pressure sensitive adhesive material.

As illustrated by FIGS. 5, 8, and 10, The release film 60 of the system 10 may include a body 61 with an outer periphery 62. The outer periphery 62 may include a number of (e.g., four, etc.) different edges 63, 64, 65, 66. In some embodiments, the outer periphery 62 may impart the body 61 with a shape that corresponds to or corresponds substantially to shapes of the protective layer 20 (FIG. 1) and the dust removal layer (FIG. 3). A body 61 with an outer periphery 62 that corresponds substantially to the shape of the protective layer 20 and the dust removal layer 40 may lack one or more features of the protective layer 20 (e.g., one or more cutouts of the protective layer 20, etc.) and the dust removal layer 40 (e.g., the tabs 54, 56, etc.). A body 61 with an outer periphery 62 that corresponds substantially to the shape of the protective layer 20 and/or the shape of the dust removal layer 40 may include one or more features in addition to those of the protective layer 20, such as a tab 78.

The release film 60 may include a tab 78. The tab 78 may protrude laterally from, or beyond, the outer periphery 62 of the body 61 of the release film 60. More specifically, the tab 78 may protrude from an end edge 63 (e.g., a top edge, etc.) of the outer periphery 62.

The body 61 of the release film 60 and, thus, the release film 60 itself may include a contact surface 67 and an outer surface 69. The contact surface 67 may be positioned adjacent to or against the dust removal surface 48 of the dust removal layer 40, as shown in FIG. 8. The dust removal adhesive 49 on the dust removal surface 48 of the dust removal layer 40 may hold the release film 60 in place adjacent to the dust removal surface 48. The outer surface 69 may be located opposite from, or on an opposite side, or surface, of the body 61 from, the contact surface 67.

The body 61 and any tab 78 of the release film 60 may be flexible. Such a release film 60 may be defined from a paper product or a polymer film (e.g., polyethylene terephthalate (polyester or PET), polypropylene (PP), polyethylene (PE), etc.). The contact surface 67 of the release film 60 may have a configuration that enables it to be readily released the dust removal adhesive 49 on the dust removal surface 48 of the dust removal layer 40. In some embodiments, the contact surface 67 may comprise a silicone coating, which may or may not include a controlled release additive, as known in the art. In the specific embodiment depicted by FIG. 8, the release film 60 may comprise a film with a weight of about 1 pound and a thickness of about 0.05 mm.

FIGS. 1 and 8 show the optional application layer 80 of the system 10. The application layer 80 may include a body 81 with an outer periphery 82. The outer periphery 82 may include a number of (e.g., four, etc.) different edges 83, 84, 85, 86. In some embodiments, the outer periphery 82 may impart the body 81 with a shape that corresponds substantially to a shape of the protective layer 20 of the system 10. A body 81 with an outer periphery 82 that corresponds substantially to the shape of the protective layer 20 may lack features of the protective layer 20 (e.g., cutouts, etc.).

The body 81 of the application layer 80 and, thus, the application layer 80 itself may also include an outer surface 87 and a contact surface 88. The contact surface 88 may be configured for placement adjacent to the outer surface 29 of the protective layer 20. The contact surface 88 may carry an adhesive 89 (e.g., a pressure sensitive adhesive, etc.) that can secure the application layer 80 to the outer surface 29. The outer surface 87 of the application layer 80 may be located opposite from, or on an opposite side, or surface, of the body 81 from, the contact surface 88.

In some embodiments, the body 81 of the application layer 80 may be flexible. Such an application layer 80 may be defined from a polymer (e.g., a polyethylene terephthalate (polyester or PET), etc.). In the specific embodiment depicted by FIG. 8, the application layer 80 comprises a PET film with a thickness of 0.06 mm.

The adhesive 89 on the contact surface 88 of the application layer 80 may secure the application layer 80 to the contact surface 27 of the protective layer 20. In addition, upon removal of the application layer 80 from the contact surface 27 of the protective layer 20, substantially no residue or no residue of the adhesive 89 may remain on the contact surface 27. The adhesive 40 may comprise a suitable pressure sensitive adhesive material.

Referring now to FIGS. 12-19, an embodiment of a method for cleaning a surface 102 of a substrate, such as the depicted electronic device 100, and applying a protective layer 20 to the surface 102 is described. Such a method may include providing a system 10 according to this disclosure (see also FIGS. 1, 8, and 10).

In FIG. 12, an individual may grasp the tab 78 that protrudes from an edge 63 of the outer periphery 62 of the body 61 of the release film 60. For example, the user may grasp the tab 78 between his or her thumb and index finger. While grasping the tab 78, the user may pull the tab 78 at least partially over a remainder of the system 10 (e.g., along its height in the embodiment of system 10 depicted by FIG. 12, etc.), pulling the release film 60 away from, or peeling the release film 60 from, the dust removal layer 40. As the release film 40 is peeled from the dust removal layer 40, the dust removal adhesive 49 and the dust removal surface 48 that carries the dust removal adhesive 49 are exposed. An entirety of the release film 60 may be removed from the dust removal layer 40.

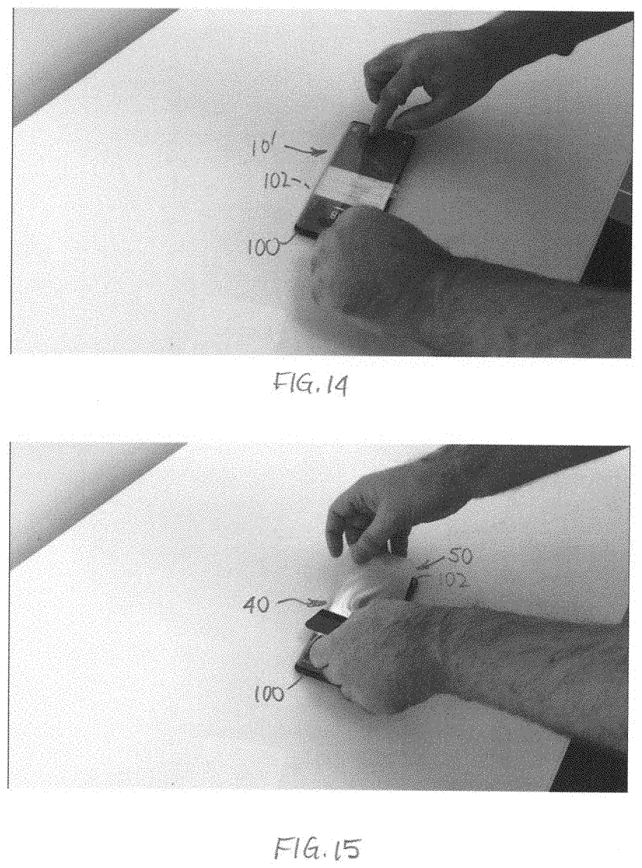

With the dust removal adhesive 49 exposed, the dust removal layer 40 may be aligned with the surface 102 of the electronic device 100 and the dust removal adhesive 49 may be placed into contact with a surface 102, as shown in FIG. 13. The assembly 10′ of the dust removal film 40, the protective layer 20, and the optional application layer 80 (see, e.g., FIG. 8) may be pressed against the surface 102 to ensure that the dust removal adhesive 49 (FIG. 12) contacts and adheres to contaminants on the surface 102. In some embodiments, the process may be repeated at least once by pulling the assembly 10′ away from (e.g., lifting the assembly 10′ off of, etc.) the surface 102, bringing the dust removal adhesive 49 back into contact with the surface 102 and any contaminants remaining thereon, and optionally pressing (or re-pressing) the assembly 10′ against the surface 102. The assembly 10′ may be aligned with the surface 102, with the dust removal adhesive 49 temporarily securing the assembly 10′ to the surface 102, as shown in FIG. 14.

Next, as depicted by FIG. 15, with the dust removal layer 40 aligned with the surface 102 of the electronic device 100 and secured to the surface 102 by way of the dust removal adhesive 48 (FIG. 12), a first section 50 of the dust removal layer 40 may be pulled away from the surface 102. The first section 50 may be pulled away from the surface 102 while a second section 52 of the dust removal layer 40 remains on (e.g., adhered to, etc.) another portion of the surface 102. As the first section 50 is pulled away from the surface 102, contaminants (e.g., contaminants from the surface of the electronic device, etc.) that have adhered to the dust removal adhesive 49 (FIG. 12) on the first section 50 may also be pulled away from the surface 102.

As illustrated by FIG. 16, while the first section 50 of the dust removal layer 40 is spaced apart from the surface 102 of the electronic device 100, the first section 50 may be removed from a corresponding first portion of the contact surface 27 (FIG. 8) of the protective layer 20 (FIG. 8). Removal of the first section 50 from the protective layer 20 may be initiated from a somewhat intermediate location across an edge 24 of an outer periphery 22 of the protective layer 20. Without limitation, removal of the first section 50 may be initiated by pulling a tab 52 (FIGS. 3 and 9) protruding from the edge 24 of the first section 50 of the dust removal layer 40 away from the protective layer 20. As the first section 50 is removed from the first portion 30 of the protective layer 20, adhesive 28 (FIG. 8) on a first portion of the contact surface 27 of the protective layer 20 may be exposed and the first portion of the contact surface 27 may be pulled toward the surface 102 of the electronic device 100, which may enable the adhesive 28 to secure the first portion of the contact surface 27 to the surface 102. In a more specific embodiment, as the first section 50 of the dust removal layer 40 is removed from the first portion 30 of the protective layer 20, adhesive 28 on the first portion of the contact surface 27 may be progressively (e.g., from the intermediate location to an edge 25 of the protective layer 20, etc.) exposed and the first portion of the contact surface 27 may be progressively pulled toward the surface 102 of the electronic device 100 to progressively secure the first portion 30 of the protective layer 20 to the surface 102.

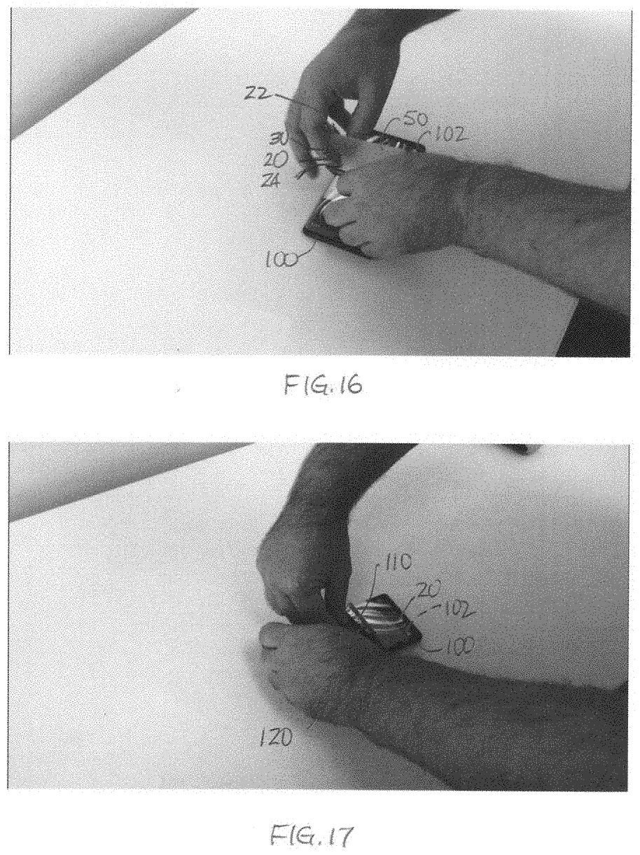

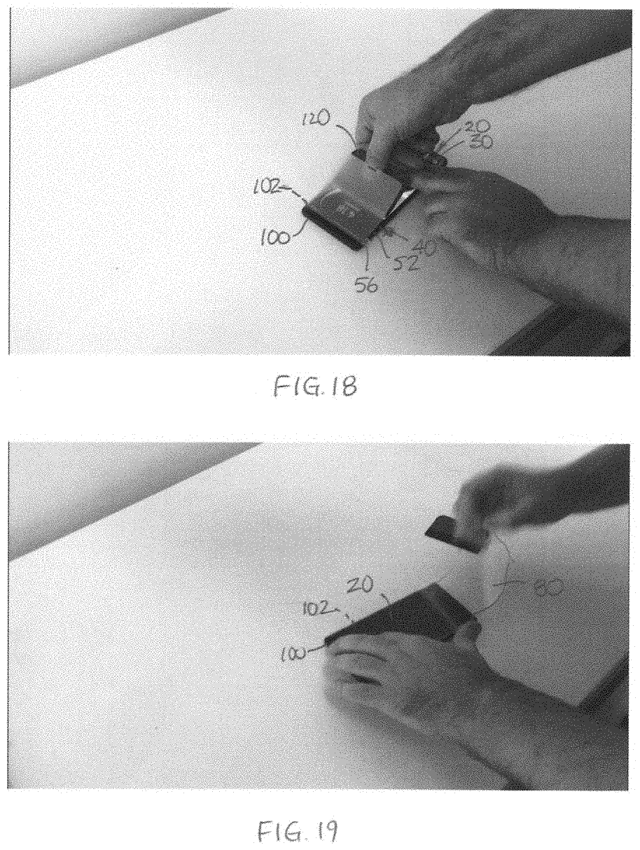

An elongated pressure front 110 may be applied to the first portion 30 of the protective layer 20 as it is secured to the surface 102 of the electronic device 100, as depicted by FIG. 17. An elongated pressure front 110 may be generated simply by pulling the first section 50 of the dust removal layer 40 from the intermediate location of the protective layer 20 toward an edge of the protective layer and a corresponding location of the electronic device, as shown in and described in reference to FIG. 16. An elongated pressure front may also be applied by positioning an application element 120 (e.g., a squeegee, a somewhat flexible card, etc.) over the outer surface 29 (FIG. 8) of the protective layer 20 (e.g., to an application layer 80 (FIG. 8) on the outer surface 29 of the protective layer 20, directly to the outer surface 29 of the protective layer, etc.) and across a portion (e.g., an intermediate portion, etc.) of the protective layer 20, and moving the application element 120 over the first portion 30 of the protective layer 30, to an edge 25 of the protective layer 20.

Removal of the first portion 50 of the dust removal layer 40 and securing the first portion 30 of the protective layer 20 to the surface 102 of the electronic device 100 may occur substantially concurrently or concurrently. More specifically, a pressure front 110 may be generated (e.g., with an application element 120, etc.) and moved across the first portion 30 of the protective layer 20 while the first portion 50 of the dust removal layer 40 is removed from the protective layer 20. FIGS. 16 and 17 illustrate an embodiment of such substantially concurrently removing the first portion 50 of the dust removal layer 40 from the protective layer 20 and securing the first portion 30 of the protective layer 20 to the surface 102.

With the first portion 30 of the protective layer 20 secured to a corresponding portion of the surface 102 of the electronic device 100, as shown in FIG. 18, the second section 52 of the dust removal layer 40 may be pulled away from, or lifted off, the surface 102 of the electronic device 100, removed from the second portion 32 of the protective layer 20, and the second portion 32 of the protective layer 20 may be secured to a corresponding portion of the surface 102. These processes may be conducted in the manner described in reference to FIGS. 15-17, by pulling the tab 56 associated with the second section 52 or simply by using an application element 120.

Once the protective layer has been secured to the surface 102 of the electronic device 100, any bubbles between the protective layer 20 and the surface 102 may be removed (e.g., by application and movement of elongated pressure fronts, etc.). In embodiments where an application layer 80 is positioned on the outer surface 29 of the protective layer 20, the application layer 80 may be removed from the outer surface 29, for example, by pulling, or peeling, the application layer 80 away from the outer surface 29 of the protective layer 20, as shown in FIG. 19.

Although this disclosure provides many specifics, the specifics should not be construed as limiting the scope of any appended claim, but merely as providing information pertinent to some specific embodiments that may fall within the scopes of the appended claims. Features from different embodiments may be employed in combination. In addition, the scope of each appended claim may encompass other embodiments. All additions to, deletions from, and modifications of the disclosed subject matter that fall within the scopes of the claims are to be embraced by the claims.

What is claimed:

1. A system for protecting a display of an electronic device, comprising:
a protective layer including an outer surface and a contact surface;
an optically clear adhesive on the contact surface of the protective layer, the optically clear adhesive capable of securing the protective layer to a display of an electronic device;
a dust removal layer including a contact surface and a dust removal surface, the contact surface of the dust removal layer facing and secured to the contact surface of the protect layer by the optically clear adhesive, the dust removal layer covering an entirety of the contact surface of the protective layer, the dust removal layer comprising:
a first section covering a first portion of the contact surface of the protective layer; and
a second section covering a second portion of the contact surface of the protective layer;
a dust removal adhesive on the dust removal surface of the dust removal layer, the dust removal adhesive capable of adhering to contaminants on the display of the electronic device and of substantially removing the contaminants from the display of the electronic device while remaining on the dust removal surface and without leaving a residue on the display; and
a release film secured to the dust removal surface of the dust removal layer by the dust removal adhesive.

2. The system of claim 1, wherein the protective layer is optically clear.

3. The system of claim 1, wherein a first edge of the first section of the dust removal layer and a second edge of the second section of the dust removal layer abut one another.

4. The system of claim 3, wherein the first edge and the second edge are separated from one another by a score line.

5. The system of claim 4, wherein the score line does not extend into the contact surface of the protective layer.

6. The system of claim 4, wherein the score line enables separation of the first edge and the second edge.

7. The system of claim 4, wherein the score line separates the first edge from the second edge.

8. The system of claim 1, wherein the release film covers an entirety of the contact surface of the dust removal layer.

9. The system of claim 1, wherein the release film comprises a single element.

10. The system of claim 1, wherein shapes and lateral dimensions of the protective layer, the dust removal layer, and the release film are substantially the same.

11. The system of claim 1, wherein the dust removal layer further comprises:
a first tab protruding from the first section of the dust removal layer at a second edge of the dust removal layer, a first edge of the first tab continuous with the first edge of the first section of the dust removal layer; and
a second tab protruding from the second section of the dust removal layer at the second edge of the dust removal layer, a second edge of the second tab continuous with the second edge of the second section of the dust removal layer, the second tap and the first tab being positioned adjacent to one another.

12. The system of claim 11, wherein the release film includes a tab protruding from a first edge of the release film, beyond a first edge of the protective film and beyond a first edge of the dust removal layer.

13. The system of claim 12, wherein:
the first edge of the release film comprises an end of the release film; and
the second edge of the dust removal layer comprise a side of the dust removal layer.

14. The system of claim 1, further comprising:
an application layer including an outer surface and a backside, the application layer positioned over the outer surface of the protective layer, with the backside of the application layer facing the outer surface of the protective layer; and
an application layer adhesive securing the backside of the application layer to the outer surface of the protective layer.

15. The system of claim 14, wherein the shapes and lateral dimensions of the protective layer, the dust removal layer, and the release film are substantially the same.

16. A method for protecting a display of an electronic device, comprising:
removing an entirety of a release film a dust removal layer to expose a dust removal adhesive on a dust removal surface of the dust removal layer;
aligning the dust removal layer with a display of an electronic device, including aligning a protective film superimposed with the dust removal layer with the display of the electronic device;
placing the dust removal adhesive into contact with display of the electronic device, the dust removal adhesive adhering to contaminants on the display of the electronic device;
lifting a first section of the dust removal layer and contaminants on the dust removal adhesive on the first section of the dust removal layer away from the display of the electronic device while a second section of the dust removal layer remains on the display of the electronic device;
simultaneously removing the first section of the dust removal layer from a first portion of the protective layer and securing the first portion of the protective layer to the display of the electronic device;
lifting the second section of the dust removal layer and contaminants on the dust removal adhesive on the second section of the dust removal layer away from the display of the electronic device while the first portion of the protective layer remains adhered to the display of the electronic device; and
simultaneously removing the second section of the dust removal layer from a second portion of the protective layer and securing the second portion of the protective layer to the display of the electronic device.

17. The method of claim 16, further comprising:
repeatedly bringing the dust removal adhesive into and out of contact with the display of the electronic device.

18. The method of claim 16, wherein simultaneously removing the first section of the dust removal layer from the first portion of the protective layer and securing the first portion of the protective layer to the display of the electronic device comprises applying a first elongated pressure front to the protective layer from a central location to a first peripheral location.

19. The method of claim 18, wherein simultaneously removing the second section of the dust removal layer from the second portion of the protective layer and securing the second portion of the protective layer to the display of the electronic device comprises applying a second elongated pressure front to the protective layer from the central location to a second peripheral location.

20. The method of claim 19, wherein applying the first elongated pressure front and applying the second elongated pressure front comprise applying the first elongated pressure front and the second elongated pressure front in opposite directions.

21. The method of claim 19, wherein applying the first elongated pressure front and applying the second elongated pressure front comprise applying the first elongated pressure front and the second elongated pressure front to the protective layer through an application layer over the protective layer.
